(19) United States
(12) Patent Application Publication
(10) Pub. No.: US 2006/0040205 A1
(43) Pub. Date: Feb. 23, 2006

(54) Planographic printing plate precursor

(75) Inventors: Ikuo Kawauchi, Shizuoka-ken (JP); Ryuki Kakino, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/204,023

(22) Filed: Aug. 16, 2005

(30) Foreign Application Priority Data
Aug. 16, 2004 (JP) 2004-236766

(51) Int. Cl. G03C 1/76

(52) U.S. Cl. 430/270.1

(57) ABSTRACT

A planographic printing plate precursor according to the invention includes: a support; and a recording layer disposed on the support and containing an alkali-soluble polymer compound and an infrared absorber, wherein a contact angle at a surface of the planographic printing plate precursor is 70° or less in a case of oil in water and 140° or more in a case of water in oil. Examples of a method for achieving such surface physical properties include inclusion, in a recording layer, of a polymer having a lipophilic functional group on a side chain thereof. According to the invention, a planographic printing plate precursor for direct print making can be obtained, which precursor improves the image forming property of the recording layer using an alkali-soluble polymer compound, is excellent in the lipophilicity of an image portion and the removing property of a non-image portion, and produces printed matters of high quality with excellent reproducibility even in the image formation with an FM screen or high number of output lines.

### CROSS-REFERENCE TO RELATED APPLICATION

This application claims priority under 35 USC 119 from Japanese Patent Application No. 2004-236766, the disclosure of which is incorporated by reference herein.

### BACKGROUND OF THE INVENTION

1. Field of the Invention

The invention relates to a planographic printing plate precursor, in particular, a planographic printing plate precursor that can be used in a so-called direct plate making process where digital signals from a computer or the like are directly used for plate-making and that can form an image by use of an infrared laser exposure process.

2. Description of the Related Art

Recently, a system where digital data from a computer are directly used for plate-making process is gathering attention, and various technologies are under development.

In particular, a recent development in laser technology is remarkable. In solid lasers and semiconductor lasers that have an emission region in particular in a region from near infra-red to infra-red, ones having higher output power and a smaller size can be readily obtained, and these are very useful as an exposure light source when digital data are directly processed for plate making. With advance in such instruments, printing with an FM screen or high number of line output is becoming rapidly common in practice.

In a so far known infrared laser type positive planographic printing plate for direct print making, an alkaline aqueous solution-soluble resin that has a phenolic hydroxyl group such as a novolak resin is used. For instance, an image formation material in which a substance that absorbs light and generates heat, various types of onium salts, and quinone diazide compounds are added to an alkaline aqueous solution-soluble resin that has a phenolic hydroxyl group such as a novolak resin has been proposed ((Japanese Patent Application Laid-Open (JP-A) No. 07-285275). In the image formation materials, in an image portion, an onium salt and quinone diazide compounds work as a dissolution inhibiter of the alkaline aqueous solution-soluble resin, and, in a non-image portion, the onium salt and quinone diazide compounds are decomposed by the action of heat to be incapable of exhibiting the dissolution inhibiting property, and thereby can be removed by developing. Thus, an image results.

In such image formation materials, since the onium salt, quinone diazide compounds and so on have a light absorption region in the visible region (350 to 500 nm), there is an inconvenience in that a place where these can be handled is limited to a place under yellow light.

Furthermore, the novolak resins or the like have an alkali-soluble group in a molecule; accordingly, the strength in the image portion is insufficient. Accordingly, in particular, there is a problem in the reproducibility of high definition images such as images, halftone dots and thin lines that are formed with an FM screen.

With an intention to improve the dissolution resistance of the image portion to improve the formability of high definition images, a photosensitive composition that includes a copolymer that has a (meth)acrylate monomer having 2 to 3 perfluoroalkyl groups as a polymerization component and a planographic printing plate precursor using the composition have been proposed (JP-A Nos. 2000-187318 and 2003-21907). These composition and the printing precursor are useful in improving the developing resistance of the image portion. However, since the composition and the printing precursor are high in the oil repellent property, the solubility in the non-image portion and the lipophilicity of the image portion thereof tend to be deteriorated.

### SUMMARY OF THE INVENTION

Accordingly, an object of the invention is to provide a planographic printing plate precursor for direct plate making, which precursor is improved in image formability of a recording layer using an alkali-soluble polymer compound, excellent in the lipophilicity of an image portion and the removing property of a non-image portion, and can obtain prints of high quality excellent in the image reproducibility, even in the image formation with an FM screen or high number of line output.

The present inventors, after studying hard, found out that, when specific physical properties are imparted to a surface of a recording layer, the foregoing problems can be overcome, thereby achieving the invention.

That is, the invention provides a planographic printing plate precursor comprising: a support; and a recording layer provided on the support, the recording layer including an alkali-soluble polymer compound (which will be referred to as “an alkali-soluble resin” hereinafter) and an infrared absorber, wherein a contact angle at a surface of the planographic printing plate precursor is 70° or less in the case of oil in water (O/W) and 140° or more in water in oil (W/O). Such a planographic printing plate precursor enables recording with laser exposure and can be used for direct plate-making from digital data of a computer.

Examples of a preferable method for imparting such physical properties to a recoding layer surface include a method of introducing a polymer that has a lipophilic functional group on a side chain, to the recording layer. Furthermore, regarding the configuration of the recording layer, preferable examples thereof include one in which the recording layer has a multi-layer structure and the uppermost layer thereof has the foregoing physical properties, and one in which at least two types of alkali-soluble polymer compounds are included and these compounds form a dispersion phase.

In the invention, since a contact angle at a surface of a recording layer of a planographic printing plate precursor is 70° or less in the case of oil in water and 140° or more in the case of water in oil, an image region is high in the lipophilicity and low in the affinity with water, resulting in excellent inking property and less waste sheets inevitably produced at the start of printing with dampening water added. Furthermore, the planographic printing plate precursor of the present invention also exhibits, in a high definition image, good developing resistance and inking property of an image portion. As a result, even a non-image portion as a small area between image portions is excellent in the ink removal property, whereby a problem such as ghost is less likely to occur, and printed matter of high quality can be obtained.

In a preferable aspect of the present invention, there is provided, as a recording layer having such surface physical properties, a recording layer having a multi-layer structure, a surface of a top layer thereof achieving the aforementioned physical properties and a lower layer thereof being a layer having excellent solubility in the alkali. Alternatively, there is provided a recording layer in which a dispersion phase is formed by at least two types of alkali-soluble resins, a dispersion phase including a resin of which alkali-solubility is excellent.

In the invention, as the recording layer as described above is used and the advantages in physical properties thereof are utilized, a superior effect is obtained in which the removal property in the non-image portion is improved and an improvement in the development latitude of the recording layer is realized.

According to the invention, a planographic printing plate precursor for direct plate making, which precursor is improved in image forming property of a recording layer using an alkali-soluble polymer compound, excellent in the lipophilicity of an image portion and the removal property in a non-image portion, and can obtain printed matters of high quality excellent in the image reproducibility, even in the image formation with an FM screen or high number of lines output.

### DETAILED DESCRIPTION OF THE INVENTION

In what follows, the invention will be detailed.

A recording layer of a planographic printing plate precursor according to the invention includes an alkali-soluble polymer compound and an infrared absorber, wherein a contact angle at a surface of the recording layer is 70° or less in oil in water and 140° or more in water in oil.

More preferably, a contact angle in oil in water is 65° or less and that in water in oil is 145° or more.

The contact angle in oil in water and that in water in oil in the invention can be measured by use of contact angle analyzer with pure water and squzole.

A recording layer having such surface physical properties and being excellent in the lipophilicity, developing resistance and inking property, can form a high definition image. In the invention, a method of controlling the surface physical properties of the recording layer within the foregoing range is not particularly restricted. However, a method where for instance a polymer having a lipophilic functional group on a side chain is added as an additive can be preferably cited.

As a polymer that has a lipophilic functional group on a side chain and can be preferably used in the invention (which polymer will be referred to as a “lipophilic polymer” hereinafter), specifically, a polymer having, as the lipophilic functional group, a substituent group having 5 or more carbon atoms on a side chain can be exemplified. As such a lipophilic functional group, an alkyl group having 6 or more carbon atoms, preferably, substantially 6 to 18 carbon atoms, a cycloalkyl group, a bicyclo ring or a tricyclo ring can be raised as examples. A polymer including a monomer having such a functional group on a side chain as a copolymerization component can be preferably used in the invention.

Specific examples of monomers that have a lipophilic functional group and are preferable as a copolymerization component of a lipophilic polymer [monomer (O-1) to (O-10)] are shown below. However, the invention is not restricted thereto.

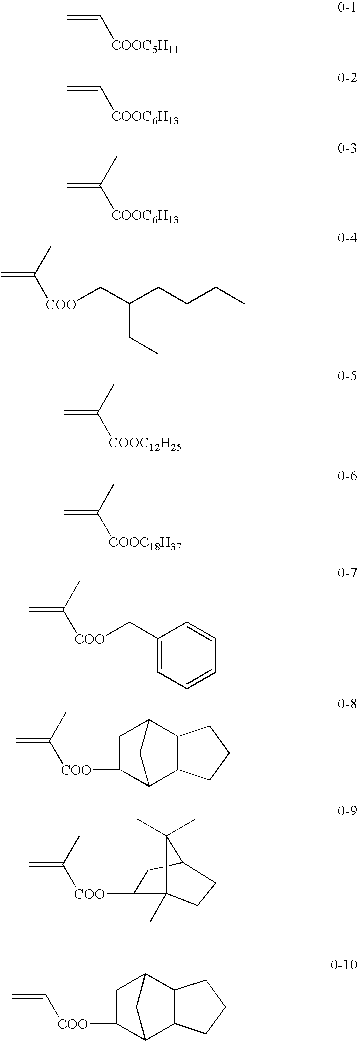

From a viewpoint of improving the lipophilicity, it is preferable that in a lipophilic polymer that can be used in the invention such a lipophilic monomer is contained at a ratio in the range of 10 to 60% by mole.

The lipophilic polymer according to the invention is preferably a copolymer that contains the foregoing lipophilic monomer. As a preferable copolymerization component, a monomer having a fluoroalkyl group can be cited. When such a monomer is contained, the localization of the lipophilic polymer at a surface of a recording layer can be heightened. As a preferable copolymerization component, an acrylic monomer having a fluoroalkyl group or a monomer having siloxane having an alkyl group having 5 or more carbon atoms or a cycloalkyl group can be cited.

Specific examples of monomers that are preferable as a copolymerization component of a lipophilic polymer and have a fluoroalkyl group [monomers (F-1) to (F-8)] are shown cited; however, the invention is not restricted thereto.

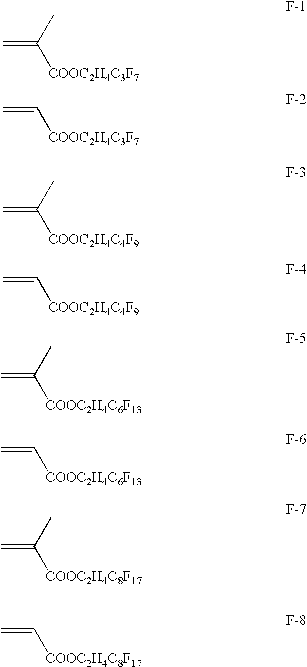

From a viewpoint of facilitating the localization of the lipophilic polymer at a surface of the recording layer, it is preferable that each lipophilic polymer of the present invention contains 5 to 50 mol % of a monomer having a fluoroalkyl group as described above.

Furthermore, in order to suppress scums from being produced in the development process at the plate making of a planographic printing plate and to improve the removing property of a non-image portion, a monomer having an acid group is preferably contained as a copolymerization component.

As an acid group, such ones as (1) to (6) below can be preferably cited.
(1) Phenol group (—Ar—OH).
(2) Sulfonamide group (—SO₂NH—R).
(3) Substituted sulfonamide type acid group (hereinafter, referred to as activated imide group) [—SO₂NHCOR, —SO₂NHSO₂R, —CONHSO₂R].
(4) Carboxylic acid group (—CO₂H).
(5) Sulfonic acid group (—SO₃H).
(6) Phosphoric acid group (—OPO₃H₂).

In the above-exemplified (1) to (6), Ar denotes a substituted/unsubstituted divalent aryl bonding group and R denotes a substituted/unsubstituted hydrocarbon group.

Among these, (2) a sulfoneamide group, (4) a carboxylic acid group and the like are preferable.

Hereinafter, specific examples of monomers that are preferable as a copolymerization component of a lipophilic polymer and have an acid group [monomers (A-1) to (A-8)] are shown; however, the invention is not restricted thereto.

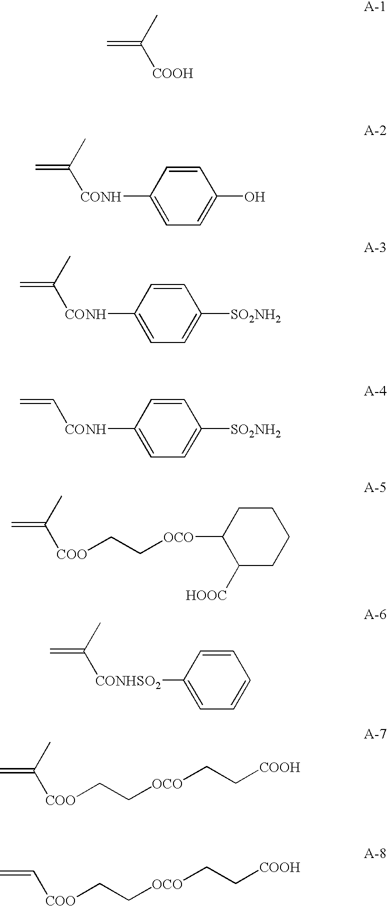

From a viewpoint of suppressing scums from being produced in a developing bath, which is problematic when an automatic processor is used, it is preferable that a monomer having such an acid group as described above is contained at a ratio in the range of 3 to 50% by mole in a lipophilic polymer to be used in the invention. When the content thereof is excessive, the lipophilicity tends to deteriorate, which is not preferalbe.

Copolymers of a monomer having the lipophilic functional group, a monomer containing a fluoroalkyl group and a monomer having an acid group preferably have a weight average molecular weight substantially in the range of 5000 to 50000.

Furthermore, as preferable lipophilic polymers other than foregoing copolymers, silicon base polymers such as shown below can be cited.

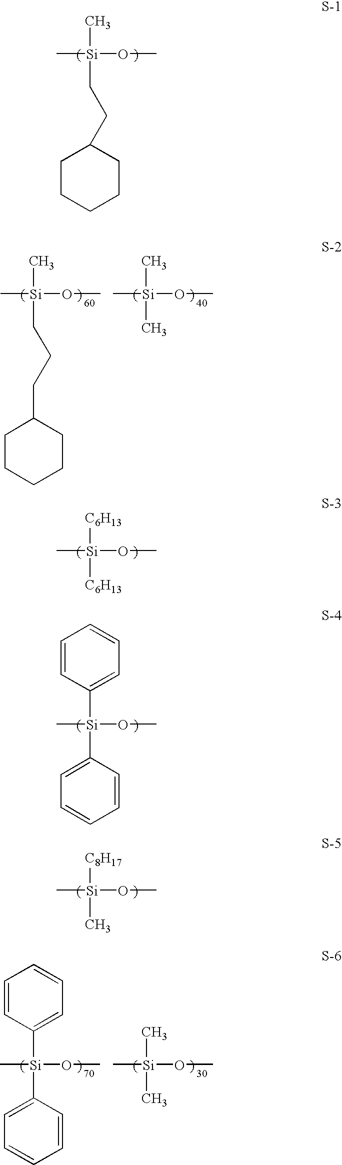

A weight average molecular weight of the silicon base polymers is preferable to be substantially in the range of 3000 to 100000.

In order to obtain the surface physical properties of the recording layer, which are essential in the invention, such a lipophilic polymer is contained in a photosensitive layer, in terms of solid content, preferably in a range of 2 to 50 mg/m², and more preferably in a range of 3 to 30 mg/m².

A recording layer of a planographic printing plate precursor according to the invention must contain an alkali-soluble polymer compound (alkali-soluble resin) and an infrared absorber. Hereinafter, these indispensable components will be explained.

[Alkali-Soluble Polymer Compound]

As the aqueous alkaline solution-soluble resin relevant to the invention include homopolymers having an acidic group in the polymer main chain and/or side chain, their copolymers, and their mixtures. Among them, those having the following acidic groups (1) to (6) in the polymer main chain and/or side chain are preferable in terms of solubility in an alkaline developer and dissolution suppressing function.
(1) Phenol group (—Ar—OH).
(2) Sulfonamide group (—SO₂NH—R).
(3) Substituted sulfonamide type acid group (hereinafter, referred to as activated imide group) [—SO₂NHCOR, —SO₂NHSO₂R, —CONHSO₂R].
(4) Carboxylic acid group (—CO₂H).
(5) Sulfonic acid group (—SO₃H).
(6) Phosphoric acid group (—OPO₃H₂).

In the above-exemplified (1) to (6), Ar denotes a substituted/unsubstituted divalent aryl bonding group and R denotes a substituted/unsubstituted hydrocarbon group.

Among aqueous alkaline solution-soluble resins having an acidic group selected from the groups (1) to (6), aqueous alkaline solution-soluble resins having (1) phenol group, (2) sulfonamide group, and (3) activated imide group are preferable; aqueous alkaline solution-soluble resins having (1) phenol group and (2) sulfonamide group are more preferable in terms of the solubility in the alkaline developer, development latitude, and sufficient retention of film strength; and an aqueous alkaline solution-soluble resins having (1) phenol group is most preferable.

A minimum constitution unit that constitutes an alkali-soluble resin used in the recording layer and has a acidic group that is selected from the (1) through (6) is not necessarily restricted to one type. One obtained by copolymerizing at least two types of the minimum constitution units having the same acidic group can be used. Alternatively, one obtained by copolymerizing at least two types of minimum constitution units having different acidic groups can be used.

The copolymer contains a compound which is to be copolymerized and has an acidic group selected from the (1) through (6), in the copolymer, preferably by 10% or more by mole and more preferably by 20% or more by mole. When such a compound is contained by less than 10% by mole, improvement in the development latitude may be insufficient.

In the invention, when an alkali-soluble resin is used as a copolymer, as a compound that is copolymerized therewith, other compounds that do not contain the acidic groups according to the (1) through (6) can be used.

Examples of other compounds that do not contain the acidic group according to the (1) through (6) include compounds cited in the (m1) through (m12) below; however, the invention is not restricted thereto.

(m1) Acrylic acid esters and methacrylic acid esters having aliphatic hydroxyl groups such as 2-hydroxyethyl acrylate or 2-hydroxyethyl methacrylate.

(m2) Alkyl acrylate such as methyl acrylate, ethyl acrylate, propyl acrylate, butyl acrylate, amyl acrylate, hexyl acrylate, octyl acrylate, benzyl acrylate, 2-chloroethyl acrylate, and glycidyl acrylate.

(m3) Alkyl methacrylate such as methyl methacrylate, ethyl methacrylate, propyl methacrylate, butyl methacrylate, amyl methacrylate, hexyl methacrylate, cyclohexyl methacrylate, benzyl methacrylate, 2-chloroethyl methacrylate, and glycidyl methacrylate.

(m4) Acrylamide or methacrylamide such as acrylamide, methacrylamide, N-methylol acrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacrylamide.

(m5) Vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether.

(m6) Vinyl esters such as vinyl acetate, vinyl chloroacetate, vinyl butylate, and vinyl benzoate.

(m7) Styrenes such as styrene, α-methylstyrene, methylstyrene, and chloromethylstyrene.

(m8) Vinyl ketones such as methyl vinyl ketone, ethyl vinyl ketone, propyl vinyl ketone, and phenyl vinyl ketone.

(m9) Olefins such as ethylene, propylene, isobutylene, butadiene, and isoprene.

(m10) N-vinylpyrrolidone, acrylonitrile, and methacrylonitrile.

(m11) Unsaturated imides such as maleimide, N-acryloylacrylamide, N-acetylmethacrylamide, N-propionylmethacrylamide, and N-(p-chlorobenzoyl)methacrylamide.

(m12) Unsaturated carboxylic acid such as acrylic acid, methacrylic acid, maleic anhydride, and itaconic acid.

Preferable components of an alkali-soluble resin that is used in the formation of a recording layer in the invention will be detailed below. In a preferable alkali-soluble resin, at least any one of a monomer having a sulfoneamide group (2), a monomer having an active imino group (3) and a monomer having a phenolic hydroxyl group (1) is to be contained by 10% or more by mole, as a copolymerization component.

Examples of the monomer having a sulfoneamide group (2) include a monomer made of a low molecular weight compound that has in one molecule at least one sulfoneamide group in which at least one hydrogen atom is bonded on a nitrogen atom, and a polymerizable unsaturated bond.

Above all, low molecular weight compounds having acryloyl group, allyl group, or vinyloxy group as well as substituted or mono-substituted aminosulfonyl group or substituted sulfonylimino group in one molecule are preferable and practical examples are those defined by the following general formulas (i) to (v).

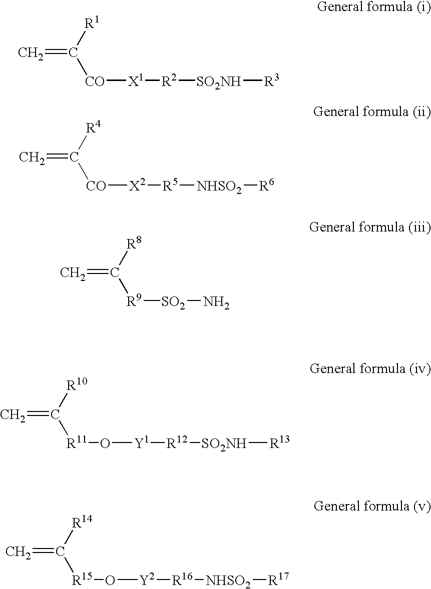

In the formula X¹ and X² independently denote —O— or NR⁷; R¹ and R⁴ independently denote hydrogen, or —CH₃; R², R⁵, R⁹, R¹² and R¹⁶ independently denote substituted/unsubstituted C₁₋₁₂ alkylene group, cycloalkylene group, arylene group, or aralkylene group; R³, R⁷, and R¹³ independently denote hydrogen, substituted/unsubstituted C₁₋₁₂ alkyl group, cycloalkyl group, aryl group, or aralkyl group; R⁶ and R¹⁷ independently denote substituted/unsubstituted C₁₋₁₂ alkyl group, cycloalkyl group, aryl group, or aralkyl group; R⁸, R¹⁰, and R¹⁴ independently denote hydrogen or —CH₃; R¹¹ and R¹⁵ independently denote C₁₋₁₂ alkylene group, cycloalkylene group, arylene group, or aralkylene group optionally having single bond or a substituent group; and Y¹ and Y² independently denote a single bond or CO.

Specifically, preferable examples thereof include m-aminosulfonylphenyl methacrylate, N-(p-aminosulfonylphenyl) methacrylamide, and N-(p-aminosulfonylphenyl) acrylamide are especially preferably used.

Examples of the monomer having an active imino group (3) include a monomer made of a low molecular weight compound that has in one molecule at least one active imino group represented by the following formula and a polymerizable unsaturated bond.

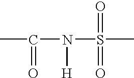

As such a compound, specifically, N-(p-toluenesulfonyl)methacrylamide, N-(p-toluenesulfonyl)acrylamide or the like can be preferably used.

A monomer corresponding to (1) is a monomer made of acrylamide, methacrylamide, acrylic acid ester, methacrylic acid ester or hydroxystyrene each having a phenolic hydroxyl group.

As such a compound, specifically, N-(4-hydroxyphenyl)acrylamide, N-(4-hydroxyphenyl)methacrylamide, o-hydroxyphenyl acrylate, m-hydroxyphenyl acrylate, p-hydroxyphenyl acrylate, o-hydroxyphenyl methacrylate, m-hydroxyphenyl methacrylate, p-hydroxyphenyl methacrylate, o-hydroxystyrene, m-hydroxystyrene or p-hydroxystyrene can be preferably used.

In the alkali-soluble resin that can be used in the recording layer according to the invention, when at least one of the (1) through (3) is contained by 10% or more by mole as a copolymerization component, the solubility of exposure percent by weight to an alkaline developing solution is improved and thereby the sensitivity can be usefully heightened.

The alkali-soluble resin according to the invention may contain another copolymerization component other than the (1) through (3) that are preferable copolymerization components.

As a copolymer that is contained in a photosensitive layer in the invention, one having a weight average molecular weight of 2000 or more and a number average molecular weight of 500 or more is preferable. More preferably, one has a weight average molecular weight in the range of 5000 to 300000, a number average molecular weight in the range of 800 to 250000 and the degree of dispersion (weight average molecular weight/number average molecular weight) in the range of 1.1 to 10.

The alkali-soluble resins that can be contained in the recording layer may be used singularly or in a combination of at least two types. The alkali-soluble resin, from a viewpoint of balance between the sensitivity, image-forming property and printing durability in an image portion, is preferably contained in a total solid content in the recording layer in the range of 30 to 98% by weight, and more preferably in the range of 40 to 95% by weight.

The recording layer may contain, other than the copolymer, for instance, a polymer compound having a phenolic hydroxyl group, specifically, a novolak resin such as a phenol formaldehyde resin, an m-cresol formaldehyde resin, a p-cresol formaldehyde resin, an m-/p-mixture cresol formaldehyde resin or a phenol/cresol (any one of m-, p-, or m-/p-mixture may be used) mixture formaldehyde resin; or a pyrogallol acetone resin.

Furthermore, as described in U.S. Pat. No. 4,123,279, a condensate between phenol that has as a substituent group an alkyl group having 3 to 8 carbon atoms and formaldehyde such as a t-butylphenol formaldehyde resin or an octylphenol formaldehyde resin may be used together. Such resins may be used singularly or in a combination of at least two types.

[Infrared absorber]

When a planographic printing plate precursor according to the invention is used to form an image with a laser that emits an infrared beam in the range of 760 to 1200 nm as a light source, from a viewpoint of improving the recording sensitivity, an infrared absorber is preferably contained in the recording layer. The infrared absorber has a function of converting absorbed infrared into heat. An exposed portion is freed from the dissolution suppressing interaction by heat generated at this time to be soluble in an alkali developing solution, and thereby removed owing to the development to form a non-image portion. An infrared absorber used in the invention may be any one as far as it is a substance that has absorption in a wavelength range of 760 to 1200 nm. Various types of known pigments, dyestuffs or dyes can be used.

As the dyes, commercialized dyes, for example, well known dyes described in documents such as “Dye Handbook” (Organic Synthetic Chemical Assoc., 1970) can be employed. Practical examples are azo dyes, metal complex azo dyes, pyrazolone azo dyes, naphthoquinone dyes, anthraquinone dyes, phthalocyanine dyes, carbonium dyes, quinonimine dyes, methine dyes, cyanine dyes, squarylium dyes, pyryllium dyes, metal thiolate complexes, oxonol dyes, diiminium dyes, aminium dyes, and croconium dyes.

Preferable dyes are, for example, cyanine dyes described in JP-A Nos. 58-125246, 59-84356, 59-202829, and 60-78787; methine dyes described in JP-A Nos. 58-173696, 58-181690, and 58-194595; naphthoquinone dyes described in JP-A Nos. 58-112793, 58-224793, 59-48187, 59-73996, 60-52940, and 60-63744; squarylium dyes described in JP-A No. 58-112792; and cyanine dyes described U.K. Patent NO. 434,875.

Near IR absorbing sensitizing agents described in U.S. Pat. No. 5,156,938 are also usable and further, substituted aryl benzo (thio) pyryllium salts described in U.S. Pat. No. 3,881,924; trimethine thiapyryllium salts described in JP-A No. 57-142645 (U.S. Pat. No. 4,327,169); pyryllium type compounds described in JP-A Nos. 58-181051, 58-220143, 59-41363, 59-84248, 59-84249, 59-146063, and 59-146061; cyanine dyes described in JP-A No. 59-216146; pentamethine thiopyryllium salts described in U.S. Pat. No. 4,283,475; and pyryllium compounds claimed in Japanese Patent Application Publication (JP-B) Nos. 5-13514 and 5-19702 are preferable to be used.

Near IR absorbing dyes defined by the formulas (I) and (II) described in U.S. Pat. No. 4,756,993 are also exemplified as preferable dyes.

Furthermore, as preferable other examples of infrared absorbing dyes according to the invention, particular indolenine cyanine dyes such as exemplified below and described in Japanese Patent Application Nos. 2001-6326 and 2001-237840 can be cited.

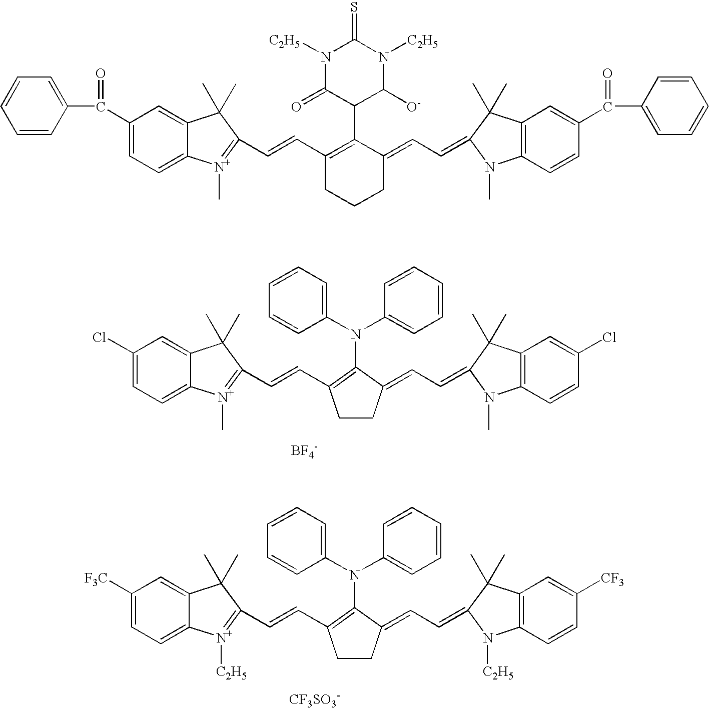

Particularly preferable among these dyes are cyanine dyes, squarylium dyes, pyrylium salts, nickel/thiolate complexes and indolenine cyanine dyes. Cyanine dyes and indolenine cyanine dyes are even more preferable. One example of especially preferable dyes is a cyanine dye represented by formula (i) shown below.

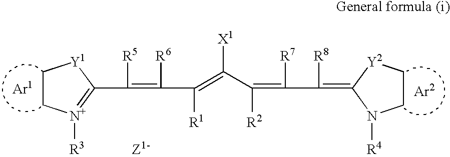

In general formula (i), X¹ represents a hydrogen atom, a halogen atom, —NPh₂, X²-L¹ (wherein X² represents an oxygen atom or a sulfur atom, L¹ represents a hydrocarbon group having 1 to 12 carbon atoms, an aromatic cyclic group having a heteroatom, or a hydrocarbon group containing a heteroatom and having 1 to 12 carbon atoms, and the heteroatom referred to herein is N, S, O, a halogen atom, or Se), or a group represented by the following: 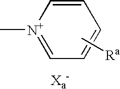
wherein Xa⁻ has the same definition as Z¹⁻, which will be described at a later time, and Ra represents a substituent selected from a hydrogen atom, an alkyl group, an aryl group, a substituted or unsubstituted amino group, or a halogen atom;
R¹ and R² each independently represents a hydrocarbon group having 1 to 12 carbon atoms, and from the viewpoint of the storage stability of the photosensitive composition of the invention when it is used in a coating solution for forming a recording layer of a planographic printing plate precursor, it is preferable that R¹ and R² each independently represents a hydrocarbon group having 2 or more carbon atoms, and more preferably R¹ and R² are bonded to each other to form a 5-membered or 6-membered ring.

Ar¹ and Ar², which may be the same or different, each represent an aromatic hydrocarbon group which may have a substituent. Preferable examples of the aromatic hydrocarbon group include benzene and naphthalene rings. Preferable examples of the substituent include hydrocarbon groups having 12 or less carbon atoms, halogen atoms, and alkoxy groups having 12 or less carbon atoms.

Y¹ and Y², which may be the same or different, each represents a sulfur atom, or a dialkylmethylene group having 12 or less carbon atoms.

R³ and R⁴, which may be the same or different, each represents a hydrocarbon group which has 20 or less carbon atoms and may have a substituent. Preferable examples of the substituent include alkoxy groups having 12 or less carbon atoms, a carboxyl group, and a sulfo group.

R⁵, R⁶, R⁷ and R⁸, which may be the same or different, each represents a hydrogen atom, or a hydrocarbon group having 12 or less carbon atoms, and since the raw materials thereof can easily be obtained, each preferably represents a hydrogen atom.

Further, Za⁻ represents a counter anion. It should be noted that when the cyanine dye represented by formula (i) has an anionic substituent in its structure and does not require neutralization of the charge, Za⁻ is not necessary. In view of storability of the coating solution of the recording layer, Za⁻ is preferably a halogen ion, a perchlorate ion, a tetrafluoroborate ion, a hexafluorophosphate ion or a sulfonate ion, and particularly preferably a perchlorate ion, a hexafluorophosphate ion or an aryl sulfonate ion.

Examples of the cyanine dyes represented by the formula (i), which can be preferably used in the invention, include those disclosed in paragraphs [0017] to [0019] of JP-A No. 2001-133969.

Yet furthermore, as especially preferable other examples of infrared absorbing dyes according to the invention, particular indolenine cyanine dyes such as exemplified described in Japanese Patent Application Nos. 2001-6326 and 2001-237840 described above can be cited.

Examples of the types of the pigments are black pigments, yellow pigments, orange pigments, brown pigments, red pigments, purple pigments, blue pigments, green pigments, phosphor pigments, metal powder pigments, and additionally, polymer-bonded dyes. Practical examples of the pigments are insoluble azo pigments, azolake pigments, condensation azo pigments, chelated azo pigments, phthalocyanine type pigments, anthraquinone type pigments, perylene type pigments, thioindigo type pigments, quinacridone type pigments, dioxazine type pigments, isoindolinone type pigments, quinophthalone type pigments, dyeing lake pigments, azine pigments, nitroso pigments, nitro pigments, natural pigments, phosphor pigments, inorganic pigments, and carbon black. Among these pigments, carbon black is preferable.

These pigments may be used without or with surface treatment. As the surface treatment, a method of surface-coating with resin or wax; a method of depositing a surfactant; and a method of bonding a reactive substance (for example, a silane coupling agent, an epoxy compound, polyisocyanate and the like) to the pigment surface are supposed to be applicable. The above-mentioned surface treatment method is described in “Property and Application of Metal Soap” (Saiwai Shobo), “Printing Ink Technology” (CMC Books, 1984), and “Newest Pigment Application Technology” (CMC Books, 1986).

The particle diameter of the pigments is preferably in a range of 0.01 μm to 10 μm, more preferably in a range of 0.05 μm to 1 μm, and most preferably in a range of 0.1 μm to 1 μm in terms of stability of a pigment dispersion in a photosensitive layer coating solution or uniformity of a photosensitive layer.

As a method for dispersing pigments, a well-known dispersing technique employed in ink production or toner production can be employed. A dispersing apparatus to be employed may be an ultrasonic dispersing apparatus, a sand mill, an attrition apparatus, a pearl mill, a super mill, a ball mill, an impeller, a disperser, a KD mill, a colloid mill, Dyantron, a three-roll mill, a pressure kneader and the like. “Newest Pigment Application Technology” (CMC Books, 1986) contains detailed description.

The infrared absorber, from viewpoints of the sensitivity and the uniformity, is contained in the recording layer, in terms of solid content, in the range of 0.01 to 50% by mass, and preferably in the range of 0.1 to 10% by mass; the dye, preferably in the range of 0.5 to 10% by mass; and the pigment, preferably in the range of 0.1 to 10% by mass.

As one of preferable aspects of a recording layer according to the invention, a layer that contains, as a monomer having such alkali solubility, 50% or more by weight of a copolymer that contains as a copolymerization component at least one selected from a group made of the following monomers (1) through (12) as a copolymerization component (hereinafter, this layer is appropriately referred to as a (A) layer) and a layer containing 50% or more by weight of a novolak resin (hereinafter, this layer is appropriately referred to as a (B) layer) are sequentially laminated to form a multi-layer structure.
(1) Acrylic acid ester and methacrylic acid ester each having an aliphatic hydroxyl group,
(2) alkyl acrylate,
(3) alkyl methacrylate,
(4) acrylamide and methacrylamide,
(5) vinyl ethers,
(6) vinyl esters,
(7) styrenes,
(8) vinyl ketones,
(9) olefins,
(10) N-pyrrolidone, N-vinyl carbazole, 4-vinyl pyridine, acrylonitrile and methacrylonitrile,
(11) unsaturated imide and
(12) unsaturated carboxylic acid.

That is, as a preferable aspect of a recording layer in the invention, a recording layer is made into a two-layer structure, and, on a side closer to a support, (A) a layer containing 50% or more by weight of a copolymer that contains as a copolymerization component at least one selected from the particular monomers selected from the (1) through (12), for instance, acrylic acid ester and methacrylic acid ester having an aliphatic hydroxyl group, alkyl acrylate, acrylamide and methacrylamide, unsaturated imide and unsaturated carboxylic acid is formed, and thereby an intermediate layer excellent in the printing durability and the solvent resistance can be formed.

Furthermore, thereon (B) a layer that contains 50% or more by weight of a novolak resin that is an alkali-soluble resin having a phenolic hydroxyl group is formed, the layer containing an infrared absorber that generates heat upon absorption of light. The alkali-soluble polymer typical in the novolak resin is strongly interactive with the infrared absorber and high in the development suppressing effect of an unexposed portion. On the other hand, the sensitivity when an image is formed owing to the exposure is also high. Accordingly, a wide development latitude can be realized. As a result, since when the lipophilic polymer is contained in the (B) layer, a polymer can be easily localized on a surface to be remarkable in the effect of the invention, this can be said a particularly preferable aspect.

In the next place, a (B) layer of a recording layer of a multi-layer structure will be described.

As a resin that has a phenolic hydroxyl group and is a primary component that constitutes the (B) layer, a novolak resin such as a phenol formaldehyde resin, an m-cresol formaldehyde resin, a p-cresol formaldehyde resin, an m-/p-mixture cresol formaldehyde resin or a phenol/cresol (any one of m-, p-, or m-/p-mixture may be used) mixture formaldehyde resin can be cited.

The novolak resins having a phenolic hydroxyl group preferably have a weight average molecular weight in the range of 500 to 20000 and a number average molecular weight in the range of 200 to 10000.

Furthermore, as described in U.S. Pat. No. 4,123,279, a condensate between phenol that has as a substituent group an alkyl group having 3 to 8 carbon atoms and formaldehyde such as a t-butylphenol formaldehyde resin and an octylphenol formaldehyde resin may be used together. Such resins having a phenolic hydroxyl group may be used singularly or in a combination of at least two types.

Furthermore, in the (B) layer, together with the novolak resin having a phenolic hydroxyl group, an infrared absorber is contained. The infrared absorber is contained among a recording layer having a multi-layer structure preferably in the (B) layer from a viewpoint of the sensitivity; however, it can be added to other layer, for instance, the (A) layer explained above.

In the invention, as the infrared absorber contained in the (B) layer, a compound that, when compatibly dissolved with a resin that is a constituent material of the (B) layer and has a phenolic hydroxyl group, lowers the solubility of the resin to an alkaline water and diminishes the solubility lowering effect owing to heating can be added. As the compound, the cyanine dyes that are represented by a formula (i) and cited in the description of the infrared absorber can be cited. An amount of a dye added to the (B) layer when the dye is used is, from a viewpoint of the sensitivity, relative to the alkali-soluble polymer, preferably in the range of 99/1 to 70/30 and more preferably in the range of 99/1 to 75/25.

To a composition constituting the (B) layer, furthermore, as needs arise, various types of additives can be added. As the additives that can be used in the (B) layer, various types of additives that are described as ones that can be added to the recording layer composition can be similarly cited.

Ordinarily, the respective components are dissolved in an appropriate solvent, followed by coating on a support, and thereby a recording layer can be formed. However, when a multi-layer recording layer such as one according to the present aspect is formed by sequentially coating according to an ordinary method, an interface of two layers becomes compatible owing to an influence of a solvent or the like, a situation where a (A) layer and a (B) layer are not clearly separated occurs; accordingly, there is a fear in that an advantage obtained from the multi-layer structure may be diminished. Accordingly, in the recording layer having a multi-layer structure, a (A) layer and a (B) layer have to be separately formed.

As a method therefor, for instance, a method that makes use of difference of the solubility in a solvent between a copolymer contained in the (A) layer and an alkali-soluble resin contained in the (B) layer, and a method in which after a second layer is coated a solvent is rapidly dried and removed can be cited. In what follows, the methods will be detailed; however, the method by which two layers are separately coated is not restricted thereto.

The method that makes use of difference of the solubility in a solvent between a copolymer contained in the (A) layer and an alkali aqueous solution-soluble resin contained in the (B) layer uses, when the alkali aqueous solution-soluble resin is coated, a solvent system in which both a particular copolymer contained in the (A) layer and a copolymer used therewith are insoluble. Thereby, even when two-layer coating is applied, individual layers can be coated clearly separated.

For instance, a copolymer that contains as a copolymerization component a particular monomer that constitutes a (A) layer component that is insoluble in a solvent such as methyl ethyl ketone or 1-methoxy-2-propanol that dissolves an alkali aqueous solution-soluble resin is selected, with a solvent system that dissolves a copolymer that constitutes the (A) layer component, a (A) layer primarily made of the copolymer is coated and dried, and thereafter a (B) layer primarily made of an alkali aqueous solution-soluble resin is coated with a solvent such as methyl ethyl ketone or 1-methoxy-2-propanol that does not dissolve the (A) layer component, and thereby two-layer structure can be realized.

On the other hand, the method in which after a second layer is coated a solvent is very speedily dried can be achieved by blowing high-pressure air from a slit nozzle disposed substantially perpendicular to a running direction of a web, by imparting heat energy as conductive heat from a bottom surface of a web by use of a roll (heat roll) supplied inside thereof with a heating medium such as vapor, or by combining these.

When a recording layer having a multi-layer structure according to the invention is formed, from viewpoints of the efficiency and expandability of a degree of freedom in composition, it is preferable to continuously coat and dry by use of a coating/drying machine that has a member that can rapidly dry a coated layer.

Furthermore, by applying coating and drying a (B) layer by disposing a machine similar to that for the (A) layer downstream a machine for coating and drying the (A) layer, further by roughening a support by disposing a roughening unit upstream a coating head of the machine for coating and drying the (A) layer, and by continuously processing by continuously running the support, the productivity can be preferably improved.

In a photosensitive image formation material according to the invention, a ratio of (A) a layer that contains 50% or more by weight of a copolymer that contains at least one of the (1) through (12) as a copolymerization component and (B) a layer that contains 50% or more by weight of an alkali aqueous solution-soluble novolak resin is, though optional, in the range of 10:90 to 95:5 by weight ratio, and particularly preferably in the range of 20:80 to 90:10.

An alkali-soluble polymer typical in a novolak resin contained in the (B) layer is strongly interactive with an infrared absorber, that is, high in the development inhibiting effect in an unexposed portion. On the other hand, it is high also in the sensitivity when an image is formed owing to the exposure. Accordingly, wide development latitude can be realized. Furthermore, since when the lipophilic polymer is contained in the (B) layer, the polymer becomes easily localized on a surface and an advantage of the invention is significant, this can be said a particularly preferable aspect.

Furthermore, as a secondary advantage, in the proximity of the support, a phenomenon that heat generated by the infrared absorber is dispersed to a support high in the thermal conductivity to lower the developability is suppressed by the presence of an intermediate layer that is the (A) layer, heat generated by the infrared absorber in the (B) layer can be efficiently used to form an image; accordingly, there are advantages in that the sensitivity and the development latitude can be improved.

Furthermore, as another preferable aspect of a recording layer according to the invention, an aspect where two or more different types of alkali-soluble resins are contained and at least one of these forms a dispersion phase can be cited. As different alkali-soluble resins, ones that are not compatible with each other or ones that show different solubility to the same solvent can be arbitrarily combined to use. As typical ones, combinations of the alkali aqueous solution-soluble resin having a phenolic hydroxyl group and the (2) a monomer having a sulfoneamide group, (3) a monomer having an active imino group and (1) acryl amide, methacryl amide, acrylic acid ester, methacrylic acid ester or hydroxystyrene each having a phenolic hydroxyl group can be cited, preferably a blending ratio by mass thereof being in the range of 50:50 to 5:95.

When a recording layer is formed with a coating solution that contains the two types of alkali-soluble resins and a micrograph (SEM photograph) of a section thereof is observed, the alkali aqueous solution-soluble resin having a phenolic hydroxy group and the copolymer are observed to form a matrix/dispersed domain structure where the copolymer containing the (1) through (3) forms a continuous phase and the alkali aqueous solution-soluble resin having a phenolic hydroxyl group forms a dispersion phase.

According to an aspect like this, the alkali aqueous solution-soluble resin having a phenolic hydroxyl group is present scattered as a dispersion phase in the copolymer and forms a state surrounded by the copolymer. Accordingly, as a whole, the nature of the alkali aqueous solution-soluble resin having a phenolic hydroxyl group is alleviated, and thereby the solvent resistance can be assumed largely improved.

Furthermore, in the invention, an infrared absorber described below and the lipophilic polymer is higher in the affinity with the alkali aqueous solution-soluble resin having a phenolic hydroxy group than with the copolymer and localized in a superficial layer. Accordingly, on a surface of the recording layer, the preferable physicality of the invention can be readily achieved, heat generation becomes abundant in the proximity of the surface, and thereby the development latitude can be assumed improved.

As a resin having a phenolic hydroxyl group, a monomer represented by (1) through (3) and a particular copolymer containing these each used in the second preferable aspect, ones similar to compounds detailed, respectively, in the recording layer can be used, and one type or a combination of at least two types can be used for each. The resins, from viewpoints of the sensitivity and the durability, are used in a content in the range of 30 to 99% by weight as a solid content in the recording layer composition, preferably in the range of 40 to 95% by weight, and particularly preferably in the range of 50 to 90% by weight.

When a recording layer having a dispersion phase like a second aspect is formed, different two types or more of alkali-soluble resins and an infrared absorber are dissolved and dispersed in an appropriate solvent to prepare a composition for forming a recording layer, followed by coating it on a support and drying, in the course of the drying, a phase separation is caused between two types of alkali-soluble resins, and thereby a recording layer having a matrix/dispersed domain structure having a dispersion phase in a matrix is formed.

In a composition for forming a recording layer, in addition to the alkali-soluble resins and the infrared absorber, as far as an advantage of the invention is not damaged, as needs arise, various types of additives can be contained. For instance, a substance that is pyrolyzable and in an unpyrolyzed state substantially lowers the solubility of the alkali aqueous solution-soluble polymer such as a onium salt, an o-quinone diazide compound, an aromatic sulfone compound or an aromatic sulfonic acid ester compound can be preferably used together from a viewpoint of improving the dissolution inhibiting property of an image portion in a developing solution.

As the onium salt, a diazonium salt, an ammonium salt, a hosphonium salt, an iodonium salt, a sulfonium salt, a selenonium salt or an arsonium salt can be cited.

In the invention, a diazonium salt is particularly preferable. Furthermore, as particularly preferable diazonium salts, ones described in JP-A No. 05-158230 can be cited.

The quinonediazide is preferably an o-quinonediazide compound. The o-quinonediazide compound used in the invention is a compound having at least one o-quinonediazide group and having an alkali-solubility increased by being thermally decomposed. The compound may be any one of compounds having various structures.

In other words, the o-quinonediazide compound assists the solubility of the photosensitive material both from the viewpoint of the effects of being thermally decomposed, and thereby losing the function of suppressing the dissolution of the binder, and the effect that the o-quinonediazide itself is changed into an alkali-soluble material.

Preferable examples of the o-quinonediazide compound used in the invention include compounds described in J. Coser, “Light-Sensitive Systems” (John Wiley & Sons. Inc.), pp. 339-352. Particularly preferable are sulfonic acid esters or sulfonamides of o-quinonediazide made to react with various aromatic polyhydroxy compounds or with aromatic amino compounds.

Further preferable examples include an ester made from benzoquinone-(1,2)-diazidesulfonic acid chloride or naphthoquinone-(1,2)-diazide-5-sulfonic acid chloride and pyrogallol-acetone resin, as described in JP-B No. 43-28403; and an ester made from benzoquinone-(1,2)-diazidesulfonic acid chloride or naphthoquinone-(1,2)-diazide-5-sulfonic acid chloride and phenol-formaldehyde resin, as described in U.S. Pat. No. 3,046,120 and U.S. Pat. No. 3,188,210.

Additional preferable examples include an ester made from naphthoquinone-(1,2)-diazide-4-sulfonic acid chloride and phenol-formaldehyde resin or cresol-formaldehyde resin; and an ester made from naphthoquinone-(1,2)-diazide-4-sulfonic acid chloride and pyrogallol-acetone resin.

An amount of an o-quinone diazo compound added is, relative to a total solid content in the recording layer, preferably in the range of 1 to 50% by weight, more preferably in the range of 5 to 30% by weight, and particularly preferably in the range of 10 to 30% by weight. The compounds can be used singularly or in a combination of several types.

Examples of a counter ion of the above-mentioned onium salts are tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorcaprylnaphthalenesulfonic acid, dodecylbenzenesulfonic acid, 1-naphthol-5-sulfonic acid, 2-methoxy-4-hydroxy-5-benzoyl-benzenesulfonic acid, and p-toluenesulfonic acid. Among them, aromatic alkylsulfonic acid such as hexafluorophosphoric acid, triisopropylnaphthalenesulfonic acid, and 2,5-dimethylbenzenesulfonic acid are preferable.

The addition amount of additives other than the above-mentioned o-quinone diazide compound is preferably 1 to 50% by mass, more preferably 5 to 30% by mass, and furthermore preferably 10 to 30% by mass in the total solid matters in the photosensitive layer.

In order to enhance sensitivity, the photosensitive composition may also contain a cyclic acid anhydride, a phenolic compound, or an organic acid.

Examples of cyclic acid anhydride include phthalic anhydride, tetrahydrophthalic anhydride, hexahydrophthalic anhydride, 3,6-endooxy-Δ4-tetrahydrophthalic anhydride, tetrachlorophthalic anhydride, maleic anhydride, chloromaleic anhydride, α-phenylmaleic anhydride, succinic anhydride, and pyromellitic anhydride which are described in U.S. Pat. No. 4,115,128.

Examples of phenolic compound include bisphenol A, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, 4,4′,3″,4″-tetrahydroxy-3,5,3′,5′-tetramethyltriphenylmethane.

Examples of the organic acid include, sulfonic acids, alkylsulfuric acids, phosphonic acids, phosphates, and carboxylic acids, which are described in JP-A No. 60-88942 or 2-96755. Specific examples thereof include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid.

When the cyclic acid anhydride, the phenol or the organic acid is added to the printing plate material (the recording layer) of a planographic printing plate precursor, the ratio thereof in the recording layer is preferably from 0.05 to 20%, more preferably from 0.1 to 15%, and even more preferably from 0.1 to 10% by mass.

In the invention, in the recording layer, in order to improve the stability before development, a fatty acid having a large number of carbon atoms so-called wax or a derivative thereof can be added. A fatty acid, a fatty acid ester or the like having an alkyl group or alkenyl group having 6 to 32 carbon atoms (for instance, straight chain alkyl groups such as an n-hexyl group, an n-heptyl group, an n-octyl group, an n-nonyl group, an n-decyl group and an n-undecyl group; branched chain alkyl groups such as a 14-methylpentadecyl group and a 16-methylheptadecyl group; and alkenyl groups such as a 1-hexenyl group, a 1-heptenyl group, a 1-octenyl group and a 2-methyl-1-heptenyl group) are preferable. Among these, from a viewpoint of the solubility in a coating solvent, ones having an alkyl group or an alkenyl group having 25 or less carbon atoms are preferable.

Specific examples of usable compounds include, as fatty acids, enanthic acid, caprylic acid, pelargonic acid, capric acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid, lacseric acid, undecylenic acid, oleic acid, elaidic acid, cetoleic acid, erucic acid and brassidic acid can be cited. As fatty acid esters, methyl esters, ethyl esters, propyl esters, butyl esters, dodecyl esters, phenyl esters and naphthyl esters thereof can be cited. As thiofatty acid esters, methyl thioesters, ethyl thioesters, propyl thioesters, butyl thioesters or benzyl thioesters thereof can be cited. Examples of fatty acid amides include amides, methylamides and ethylamides thereof.

The compounds may be used singularly or in a combination of at least two types thereof. An amount of the compound added is, relative to a total solid content of a printing plate material, in the range of 0.02 to 10% by weight, preferably in the range of 0.2 to 10% by weight, and particularly preferably in the range of 2 to 10% by weight. When an amount of the compound added is less than 0.02% by weight, the developing stability against bruise becomes insufficient, and since an advantageous effect saturates at 10% by weight, there is no need of adding further.

Furthermore, in recording layer constituent materials, in order to expand the stability of processing to development conditions, nonionic surfactants described in JP-A Nos. 62-251740 and 03-208514 or amphoteric surfactants described in JP-A Nos. 59-121044 and 04-13149 can be added.

Specific examples of the nonionic surfactant include sorbitan tristearate, sorbitan monopalmitate, sorbitan trioleate, monoglyceride stearate, and polyoxyethylene nonyl phenyl ether.

Specific examples of the amphoteric surfactant include alkyldi(aminoethyl)glycine, alkylpolyaminoethylglycine hydrochloride, 2-alkyl-N-carboxyethyl-N-hydroxyethylimidazolium betaine, and N-tetradecyl-N,N-betaine type surfactants (trade name: “Amorgen K”, manufactured by Daiichi Kogyo Co., Ltd., and others). The content of the nonionic surfactant and the amphoteric surfactant in the materials constituting the (A) layer is preferably from 0.05 to 15% by mass, and more preferably from 0.1 to 5% by mass.

The composition for the recording layer of the invention may contain a printing-out agent for obtaining visible images immediately after heating by exposure, and a dye and a pigment may be added as an image coloring agent.

A typical example of the printing-out agent is a combination of a compound which releases an acid by being heated by exposure to light (optically acid-releasing agent) with an organic dye which can form a salt. Specific examples thereof include combinations of o-naphthoquinonediazide-4-sulfonic acid halogenide with a salt-formable organic dye, described in JP-A Nos. 50-36209 and 53-8128; and combinations of a trihalomethyl compound with a salt-formable organic dye, described in JP-A Nos. 53-36223, 54-74728, 60-3626, 61-143748, 61-151644 and 63-58440. The trihalomethyl compound is an oxazole type compound or a triazine type compound. Either of these compounds are excellent in stability over time and can give vivid printed-out images.

The image coloring agent may be the above-mentioned salt-formable organic dye or some other dye than the salt-formable organic dye, and is preferably an oil-soluble dye or a basic dye. Specific examples thereof include Oil Yellow #101, Oil Yellow #103, Oil Pink #312, Oil Green BG; Oil Blue BOS, Oil Blue #603, Oil Black BY, Oil Black BS, and Oil Black T-505 (trade name, manufactured by Orient Chemical Industries Ltd.), Victoria Pure Blue, Crystal Violet Lactone, Crystal Violet (CI42555), Methyl Violet (CI42535), Ethyl Violet, Rhodamine B (CI145170B), Malachite Green (CI42000), and methylene Blue (CI52015). Dyes described in JP-A No. 62-293247 are particularly preferable.

These dyes may be added in an amount of from 0.01 to 10% by mass, and preferably from 0.1 to 3% by mass, based on the total solid content in the recording layer composition.

The composition for the recording layer of the invention may contain a plasticizer for imparting flexibility to a coating film. Examples thereof include butyl phthalate, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl oleate and an oligomer or a polymer of acrylic acid or methacrylic acid.

Furthermore, in order to improve the film strength, a long chain fatty acid ester, a long chain fatty acid amide or the like can be added.

In a recording layer composition according to the invention, a surfactant for improving the coating property such as a fluorinated surfactant such as described in JP-A No. 62-170950 can be added. An amount of a surfactant added is preferably in the range of 0.01 to 1% by weight of the composition and more preferably in the range of 0.05 to 0.5% by weight.

A photosensitive solution that is coated on a support is used in a state where the components are dissolved in a preferable solvent. A concentration of the components (a total solid content including additives) in the solvent is preferably in the range of 1 to 50% by weight. As a coating method, various methods can be used. For instance, a bar coating method, a rotation coating method, a spray coating method, a curtain coating method, a dip coating method, an air-knife coating method, a blade coating method and a roll coating method can be cited. As an amount coated becomes smaller, the apparent sensitivity becomes higher; however, the film characteristics of the photosensitive film become deteriorated.

The support which is used in the planographic printing plate precursors of the invention may be any plate-form product that has necessary strength and endurance and is dimensionally stable. Examples thereof include a paper sheet; a paper sheet on which a plastic (such as polyethylene, polypropylene, or polystyrene) is laminated; a metal plate (such as an aluminum, zinc, or copper plate), a plastic film (such as a cellulose diacetate, cellulose triacetate, cellulose propionate, cellulose lactate, cellulose acetate lactate, cellulose nitrate, polyethylene terephthalate, polyethylene, polystyrene, polypropylene, polycarbonate, or polyvinyl acetal film); and a paper or plastic film on which a metal as described above is laminated or vapor-deposited.

Of these supports, a polyester film or an aluminum plate is preferable in the invention. An aluminum plate is particularly preferable since the plate is good in dimensional stability and relatively inexpensive. Preferable examples of the aluminum plate include a pure aluminum plate, and alloy plates comprising aluminum as the main component and a small amount of different elements. A plastic film on which aluminum is laminated or vapor-deposited may be used. Examples of the different elements contained in the aluminum alloy include silicon, iron, manganese, copper, magnesium, chromium, zinc, bismuth, nickel, and titanium. The content by percentage of the different elements in the alloy is at most 10% by mass.

In the invention, pure aluminum is particularly preferable. However, completely pure aluminum is not easily produced from the viewpoint of metallurgy technology. Thus, aluminum containing a trace amount of the different elements may be used.

As described above, the aluminum plate used in the invention, the composition of which is not specified, may be any aluminum plate that has been known or used hitherto. The thickness of the aluminum plate used in the invention is generally from about 0.1 to 0.6 mm, preferably from 0.15 to 0.4 mm, and more preferably from 0.2 to 0.3 mm.

Before the surface of the aluminum plate is roughened, the plate is subjected to degreasing treatment with a surfactant, an organic solvent, an aqueous alkaline solution or the like if desired, in order to remove rolling oil on the surface. The roughening treatment of the aluminum plate surface is performed by any one of various methods, for example, by a mechanically surface-roughening method, or a method of dissolving and roughening the surface electrochemically, or a method of dissolving the surface selectively in a chemical manner.

The mechanically surface-roughening method which can be used may be a known method, such as a ball polishing method, a brush polishing method, a blast polishing method or a buff polishing method. The electrochemically surface-roughening method may be a method of performing surface-roughening in a hydrochloric acid or nitric acid electrolyte by use of alternating current or direct current. As disclosed in JP-A No. 54-63902, a combination of the two may be used.

The aluminum plate the surface of which is roughened as described above is subjected to alkali-etching treatment and neutralizing treatment if necessary. Thereafter, the aluminum plate is subjected to anodizing treatment if desired, in order to improve the water holding ability or wear resistance of the surface. The electrolyte used in the anodizing treatment of the aluminum plate is any one selected from various electrolytes which can make a porous oxide film. There is generally used sulfuric acid, phosphoric acid, oxalic acid, chromic acid, or a mixed acid thereof. The concentration of the electrolyte may be appropriately decided dependently on the kind of the electrolyte.

Conditions for the anodizing treatment cannot be specified without reservation since the conditions vary dependently on the used electrolyte. The following conditions are generally suitable: an electrolyte concentration of 1 to 80% by mass, a solution temperature of 5 to 70° C., a current density of 5 to 60 A/dm², a voltage of 1 to 1100 V, and an electrolyzing time of 10 seconds to 5 minutes. If the amount of the anodic oxide film is less than 1.0 g/m², the printing durability is insufficient or non-image areas of the planographic printing plate are easily injured so that the so-called “injury stains”, resulting from ink adhering to injured portions at the time of printing, are easily generated.

If necessary, the aluminum surface is subjected to treatment for hydrophilicity after the anodizing treatment.

The treatment for hydrophilicity which can be used in the invention may be an alkali metal silicate (for example, aqueous sodium silicate solution) method, as disclosed in U.S. Pat. Nos. 2,714,066, 3,181,461, 3,280,734, and 3,902,734. In this method, the support is subjected to immersing treatment or electrolyzing treatment with aqueous sodium silicate solution. Besides, there may be used a method of treating the support with potassium fluorozirconate disclosed in JP-B No. 36-22063 or with polyvinyl phosphonic acid, as disclosed in U.S. Pat. Nos. 3,276,868, 4,153,461, and 4,689,272.

In the planographic printing plate precursor of the invention, in which the layer (A) and the layer (B) are provided as photosensitive layers on the support, an undercoat layer may further be provided, as necessary, between the support and the (A) layer.

As components for the undercoat layer, various organic compounds may be used. Examples thereof include carboxymethylcellulose, dextrin, gum arabic, phosphonic acids having an amino group such as 2-aminoethylphosphonic acid, organic phosphonic acids such as phenylphosphonic acid, naphthylphosphonic acid, alkylphosphonic acid, glycerophosphonic acid, methylenediphosphonic acid and ethylenediphosphonic acid, each of which may have a substituent, organic phosphoric acids such as phenylphosphoric acid, naphthylphosphoric acid, alkylphosphoric acid and glycerophosphoric acid, each of which may have a substituent, organic phosphinic acids such as phenylphosphinic acid, naphthylphosphinic acid, alkylphosphinic acid, and glycerophosphinic acid, each of which may have a substituent, amino acids such as glycine and β-alanine, and hydrochlorides of amines having a hydroxyl group, such as hydrochloride of triethanolamine. These may be used in a mixture form.

This organic undercoat layer can be formed by the following method: a method of dissolving the above-mentioned organic compound into water, an organic solvent such as methanol, ethanol or methyl ethyl ketone, or a mixed solvent thereof to prepare a solution, applying the solution onto an aluminum plate, and drying the solution to form the undercoat layer; or a method of dissolving the above-mentioned organic compound into water, an organic solvent such as methanol, ethanol or methyl ethyl ketone, or a mixed solvent thereof to prepare a solution, dipping an aluminum plate into the solution to cause the plate to adsorb the organic compound, washing the plate with water or the like, and then drying the plate to form the undercoat layer.

In the former method, the solution of the organic compound having a concentration of 0.005 to 10% by mass can be applied by various methods. In the latter method, the concentration of the organic compound in the solution is from 0.01 to 20% by mass, preferably from 0.05 to 5% by mass, the dipping temperature is from 20 to 90° C., preferably from 25 to 50° C., and the dipping time is from 0.1 second to 20 minutes, preferably from 2 seconds to 1 minute.

The pH of the solution used in this method can be adjusted into the range of 1 to 12 with a basic material such as ammonia, triethylamine or potassium hydroxide, or an acidic material such as hydrochloric acid or phosphoric acid. A yellow dye can be added to the solution in order to improve the reproducibility of the tone of the image recording material.

The coated amount of the organic undercoat layer is suitably appropriately from 2 to 200 mg/m², and preferably from 5 to 100 mg/m². In cases where the coated amount is less than 2 mg/m² or exceeds 200 mg/m², sufficient printing durability may not be obtained.

In an image forming material according to the invention, as needs arise, a protective layer can be formed on the photosensitive layer. As a protective layer component, polyvinyl alcohol and matte materials that are used in an ordinary photosensitive image forming material can be cited.

An image forming material thus formed is ordinarily subjected to image exposure and development process.

In the invention, as a light source of an active light beam that is used in the image exposure, a light source having an emission wavelength in 700 nm or more in a near infrared to an infrared region is preferable, a solid laser and a semiconductor laser being particularly preferable.

As the developer or the replenishing solution to be used for the image recording material of the invention, a conventionally known aqueous alkaline solution can be used. Examples of the solute of the solution are inorganic alkali salts such as silicates of sodium and calcium; tertiary phosphates of sodium, potassium and ammonium; secondary phosphates of sodium, potassium and ammonium; carbonates of sodium, potassium and ammonium; hydrogen carbonates of sodium, potassium and ammonium; borates of sodium, potassium and ammonium; and hydroxides of sodium, ammonium, potassium and lithium; organic alkali agents such as monomethylamine, dimethylamine, trimethylamine, monoethylamine, diethylamine, triethylamine, monoisopropylamine, diisopropylamine, triisopropylamine, n-butylamine, monoethanol amine, diethanol amine, triethanol amine, monoisopropanol amine, diisopropanol amine, ethyleneimine, ethylenediamine, and pyridine. These aqueous alkaline solutions may be used alone or in combination of two or more of them.

Among these aqueous alkaline solutions, an aqueous solution of a silicate such as sodium silicate or potassium silicate is particularly preferable. The reason for that is because the developability can be adjusted depending on the ratio and the concentration of the silicon oxide (SiO₂), a component of the silicate, and an alkali metal oxide (M₂O) and preferable examples are alkali metal silicates described in JP-A No. 54-62004 and JP-B No. 57-7427.

In the case development is carried out by using an automatic developing apparatus, addition of an aqueous solution (a replenishing solution) with a higher alkalinity than that of the developer makes it possible to carry out good treatment of a larger quantity of PS plates without replacing the developer in a development tank for a long duration. This replenishing method is preferably applied to the present invention.

For the purpose of promotion or suppression of developability, dispersion of development scum, or improvement of ink-philicity of imaging areaimage portion of a printing plate, the developer or the replenishing solution may further be mixed with a variety of surfactants and organic solvents based on the necessity. Preferable examples of the surfactants are anionic, cationic, nonionic and amphoteric surfactants. Further, reducing agents such as hydroquinone, resorcin, and inorganic acid salts such as sodium and potassium sulfites and hydrogensulfites; organic carboxylic acids; defoaming agents; and hard water softening agents may be added to the developer and the replenishing solution.

The planographic printing plate subjected to the development treatment by the developer and the replenishing solution is then subjected to post-treatment with washing water, a rinsing solution containing a surfactant, and a desensitizing solution containing gum arabic and starch derivative. The post-treatment in the case of using the image forming material of the invention as a printing plate may be carried out by variously combining the aforementioned treatment steps.

Recently, in order to make the plate-making process rational and standardize the process in plate-making and printing industries, an automatic developing apparatus for a printing plate has been used widely. The automatic developing apparatus generally comprises a development part and a post-treatment part and is provided with a unit for transporting a printing plate, respective treatment tanks, and a spraying unit and carries out development treatment by spraying respective treatment solutions pumped up by pumps while horizontally transporting an already exposed printing plate. Nowadays, a method for treating a printing plate by immersing and transporting the printing plate by guide rolls in the solution in a treatment solution tank filled with a treatment solution has been known. In such automatic treatment, treatment is carried out simultaneously with supplying replenishing solutions to the respective treatment solutions depending on the treatment quantity and operation duration.

Further, treatment with a practically unused treatment solution, what is called disposable treatment, is also employed.

A case where an image formation material according to the invention is used as a photosensitive planographic printing plate will be described.

In the case there are unnecessary imaging portions (for example, the film edge remaining of an original image film) in the planographic printing plate obtained by imagewise exposure and development of a planographic printing plate precursor and successively water washing and/or rinsing and/or gumming, the unnecessary imaging areaimage portions are removed. Such removal is preferably carried out by applying a removal solution as described in JP-B No. 2-13293 to the unnecessary imaging areaimage portions, keeping them as they are for a prescribedpredetermined duration and then washing with water. Also, a method carried out by developing after radiating active light beam led through an optical fiber described in JP-A No. 59-174842 to the unnecessary imaging areaimage portions can be employed.

The obtained planographic printing plate is supplied to a printing step after application of desensitizing gum based on necessity and if the printing durability of the planographic printing plate is further needed improvement, burning treatment is carried out.

In a case where the planographic printing plate is subjected to the baking treatment, it is preferable that before the baking treatment takes place the plate is treated with a surface-adjusting solution as described in JP-B No. 61-2518, or JP-A Nos. 55-28062, 62-31859 or 61-159655.

This method of treatment is, for example, a method of applying the surface-adjusting solution onto the planographic printing plate with a sponge or absorbent cotton infiltrated with the solution, a method of immersing the planographic printing plate in a vat filled with the surface-adjusting solution, or a method of applying the surface-adjusting solution to the planographic printing plate with an automatic coater. In a case where after application the amount of solution applied is made uniform with a squeegee or a squeegee roller, a better result can be obtained.

In general, the amount of surface-adjusting solution applied is suitably from 0.03 to 0.8 g/m² (dry mass). If necessary the planographic printing plate onto which the surface-adjusting solution is applied can be dried, and then the plate is heated to a high temperature by means of a baking processor (for example, a baking processor (BP-1300) sold by Fuji Photo Film Co., Ltd.) or the like. In this case the heating temperature and the heating time, which depend on the kind of components forming the image, are preferably from 180 to 300° C. and from 1 to 20 minutes, respectively.

If necessary, a planographic printing plate subjected to baking treatment can be subjected to treatments which have been conventionally conducted, such as a water-washing treatment and gum coating. However, in a case where a surface-adjusting solution containing a water soluble polymer compound or the like is used, the so-called desensitizing treatment (for example, gum coating) can be omitted.

A planographic printing plate obtained by processing thus from a planographic printing plate precursor according to the invention is excellent in the development resistance property and lipophilicity in an image portion; accordingly, when a printing process is carried out on an offset printing machine, waste sheets are less, and a lot of printed matters that are excellent in the reproducibility of high definition images and in quality can be obtained.

### EXAMPLES

Hereinafter, the invention will be described in accordance with examples; however, the invention is not restricted thereto.

[Preparation of Support]

JIS A 1050 aluminum plates having a thickness of 0.3 mm are processed as shown below and thereby supports 1 through 3 are prepared.

(a) Mechanical Surface Roughening Treatment

While a suspension containing a polishing agent (silica sand) with a specific gravity of 1.12 and water being is supplied as a polishing slurry to the a surface of each aluminum sheet, the and mechanical surface roughening was is carried out by rotating roller type nylon brushes. The average particle size of the polishing agent was is 8 μm and the maximum particle size was 50 μm. The material of the nylon brushes was is 6-10 nylon and hair length and hair diameters were 50 mm and 0.3 mm, respectively. The nylon brushes were are produced by implanting the hairs densely in holes formed in stainless cylinders with a diameter of φ300 mm. Three rotating brushes were are used. Two supporting rollers (φ200 mm diameter) are placed in lower parts of below the brushes were with a separation of at 300 mm distance. The brush rollers were are pushed until the load of the driving motor for rotating the brushes was is increased by to 7 kW or more from the load before than that before pushing the brush rollers were pushed against the aluminum sheet. The rotation direction of the brushes was is the same as the moving direction of the aluminum sheet. The rotation speed of the brushes was is 200 rpm.

(b) Alkaline Etching Treatment

Etching treatment was is carried out by spraying an aqueous NaOH solution (concentration 26% by weight and an aluminum ion concentration 6.5% by weight) at 70° C. to the obtained aluminum sheet in order to dissolve an amount of 6 g/m³² aluminum sheet. After that, the aluminum sheet was is washed with water by spraying.

(c) Desmut Treatment

Desmut treatment was is carried out by spraying an aqueous solution of 1% by weight nitric acid (containing an aluminum ion concentration of 0.5% by weight) at 30° C. and then the resulting aluminum sheet was is washed with water. As the aqueous nitric acid solution used for the desmut, waste solution from a step of a process of the electrochemical surface roughening in an aqueous nitric acid solution by AC (alternate current) was can be used.

(d) Electrochemical Surface Roughening Treatment

Electrochemical surface roughening treatment was can be carried out continuously by using 60 Hz AC voltage. The electrolytic solution used in this case was is an aqueous solution of nitric acid 10.5 g/L (aluminum ion 5 g/L) at 50° C. The electrochemical surface roughening can be carried out using an AC power waveform which was is a trapezoidal rectangular waveform, with the time TP from a zero current value to a the peak being of 0.8 msec and DutyUTY ratio 1:1 and usin, and g alternating current with such rectangular waveform, the electrochemical surface roughening was carried out by employing a carbon electrode as an opposed electrode. Ferrite was is used as an auxiliary anode. A radial cell type electrolytic bath wasis used.

The current density was is 30 A/dm² atas the peak value of the current and the total electricity quantity was is 220 C/dm when the aluminum sheet was is used as an anode. Five percent of the electric current flowing from the electric power was shunted throughto the auxiliary anode.

After that, the resulting aluminum sheet was is washed with a water spray.

(e) Alkali Etching Treatment

Etching treatment was can be carried out at 32° C. for on the aluminum sheet at 32° C. by spraying a solution with sodium hydroxide concentration 26% by weight and aluminum ion concentration 6.5% by weight. By doing this to dissolve 0.2 g/m² of the aluminum sheet is dissolved so as to remove the smut component of mainly aluminum hydroxide produced when carrying out the the electrochemical surface roughening by using alternating current in the prior step. It also has the effect of and also to dissolvinge the edge parts of formed pits so as to smooth the edge parts. After that, the aluminum sheet was is washed by spraying water spray.

(f) Desmut Treatment

Desmut treatment was is carried out by spraying an aqueous solution of 15% by weight nitric acid (containing aluminum ion 4.5% by weight) at 30° C. and then the resulting aluminum sheet was is washed by spraying water spray. As For the aqueous nitric acid solution used for the desmut, waste solution from the a step process of the electrochemical surface roughening in an aqueous nitric acid solution by AC was usedcan be used.

(g) Electrochemical Surface Roughening Treatment

Electrochemical surface roughening treatment was can be carried out continuously by using 60 Hz AC voltage. The electrolytic solution used in this case iswas an aqueous solution of hydrochloric acid 7.5 g/L (containing aluminum ion 5 g/L) at 35° C. The AC power waveform wasis a trapezoidal rectangular waveform and a carbon electrode is was used as an opposed electrode for the electrochemical surface roughening treatment. Ferrite was is used as an auxiliary anode. A radial cell type electrolytic bath was used.

The current density was is 25 A/dm² ats the peak value of the current and the total electricity quantity was 50 C/dm² when the aluminum sheet was is used as an anode.

After that, the resulting aluminum sheet was is washed with a water spray.

(h) Alkali Etching Treatment

Etching treatment was is carried out at 32° C. for the aluminum sheet by spraying a solution, with of sodium hydroxide concentration 26% by weight and aluminum ion concentration 6.5% by weight, to dissolve 0.10 g/m2 of the aluminum sheet. so as to This removes the smut, of which the main is component of mainly aluminum hydroxide, produced when the electrochemical surface is rougheneding by using alternating current in the prior step. and Aalso toit dissolves the edge parts of formed pits so as to smooth the edge parts. After that, the aluminum sheet was is washed by spraying water spray.

(i) Desmut Treatment

Desmut treatment was is carried out by spraying with an aqueous solution of 25% by weight sulfuric acid (containing aluminum ion 0.5% by weight) at 60° C. and then washing the resulting aluminum sheet was washed by spraying water spray.

(j) Anodization Treatment

As an electrolytic solution, sulfuric acid was is used. The electrolytic solution containsed sulfuric acid 170 g/L (aluminum ion 0.5% by weight) and was should be at 43° C. After Then the aluminum sheet was is washed with a water by spraying.

The electric current density was is about 30 A/dm². Final oxide film thickness was is about 2.7 g/m2.

(k) Alkali Metal Silicate Treatment

Each aAluminum supportsupporting bodies obtained by the anodization wasare immersed in a treatment bath of an aqueous solution containing No. 3 sodium silicate 1% by weight for 10 seconds at 30° C. to carry out alkali metal silicate treatment (silicate treatment). After that, the supportsupport was is washed by spraying water spray. The silicate deposition was is about 3.5 mg/m² at that this time.

<Support 1>

Each of the foregoing (a) through (j) steps was sequentially carried out, and the amount of etching in the step (e) was controlled so as to be 3.5 g/m², such that support 1 was prepared.

<Support 2>

Support 2 was prepared by sequentially carrying out the aforementioned steps (a) to (k) but omitting the steps (g), (h) and (i).

<Support 3>

Support 3 was prepared by sequentially carrying out the foregoing steps (a) through (k) and controlling an amount of etching in the (c) step so as to be 3.5 g/m².

[Formation of Undercoat Layer]

On each of the aluminum supports obtained as mentioned above, an undercoat solution having a composition below was coated followed by drying at 80° C. for 15 sec, whereby an undercoat layer was provided. A dry coating amount thereof was 17 mg/m².

| | |
|---|---|
| Polymer compound shown below | 0.3 g |
| Methanol | 100 g |
| Water | 1 g |

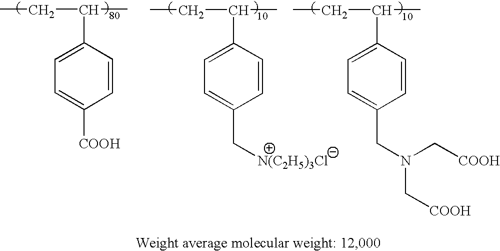

### Examples 1 through 16

(Formation of Recording Layer)

On each of the supports 1 to 3 thus obtained with an undercoat layer provided thereon, a recording layer coating solution 1 having a composition below (for formation of “a (A) layer”) was coated with a wire-bar, followed by drying at 150° C. for 60 sec in a drying oven, such that a coating amount was controlled to be 0.85 g/m². Table 1 below shows which support was used for each example.

On each of obtained supports with a (A) layer, a recording layer coating solution 2 having a composition below (for formation of “a (B) layer”) was coated with a wire-bar. After coating, by using Perfect Oven PH 200 manufactured by Tabai Corp., with Wind Control thereof set at 7, drying was carried out at 145° C. for 70 sec, such that a total coating amount was controlled to be 1.1 g/m². As a result, positive planographic printing plate precursors according to examples 1 through 16 were obtained. Furthermore, another planographic printing plate precursor was prepared as comparative example 1 in which the recording layer coating solution 2 did not contain a lipophilic polymer according to the invention. Yet another planographic printing plate precursor was prepared as comparative example 2 in which the recording layer coating solution 2 used, in place of the lipophilic polymer, a fluorinated surfactant. Yet another planographic printing plate precursor was prepared as comparative example 3 in which the recording layer coating solution 2 used, in place of the lipophilic polymer, a fluorinated polymer.

| | |
|---|---|
| <Recording layer coating solution 1 for formation of (A) layer> | |
| N-(4-aminosulfonylphenyl)methacrylamide/ | 2.13 g |
| acrylonitrile/methyl methacrylate | |
| (molar ratio: 36:34:30, weight average molecular weight: 50000) | |
| Cyanine dye A (formula shown below) | 0.134 g |
| Bis-p-hydroxyphenylsulfone | 0.126 g |
| Tetrahydrophthalate anhydride | 0.19 g |
| P-toluene sulfonic acid | 0.008 g |
| 2-methoxy-4-(N-phenylamino)benzenediazonium hexafluoro phosphate | 0.032 g |
| Ethyl violet 6-naphthalene sulfonate | 0.078 g |
| Fluorinated surfactant | 0.023 g |
| (trade name: Megafac F-780, manufactured by | |
| Dai Nippon Ink and Chemicals, Incorporated) | |
| Gamma-butyrolactone | 13.16 g |
| Methyl ethyl ketone | 25.39 g |
| 1-methoxy-2-propanol | 12.95 g |

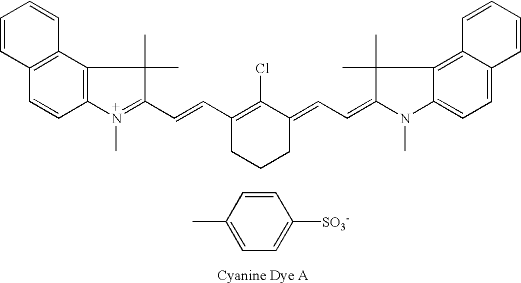

| | |
|---|---|
| <Recording Layer Coating Solution 2 for formation of (B) layer> | |
| Novolak resin (m/p-cresol (6/4), | 0.351 g |
| weight average molecular weight: 7000, | |
| unreacted cresol: 0.5% by weight) | |
| Cyanine dye A (formula shown above) | 0.029 g |
| Polymer P/MEK 30% solution (formula shown below) | 0.14 g |
| Quatemary ammonium salt (formula shown below) | 0.004 g |
| Fluorinated surfactant (trade name: Megafac F-780, | 0.004 g |
| manufactured by Dai Nippon Ink and Chemicals, Incorporated) | |
| Lipophilic polymer (a compound described in Table 1) | 0.020 g |
| Methyl ethyl ketone | 2.63 g |
| 1-methoxy-2-propanol | 5.27 g |

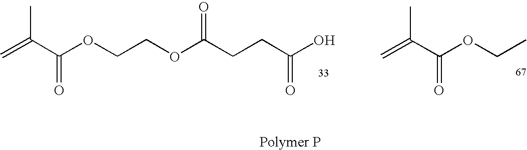

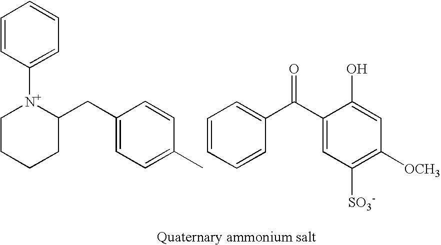

### Examples 17 through 32

On each of the supports 1 through 3 prepared as mentioned above, an undercoat solution similar to examples 1 through 16 was coated, followed by drying at 80° C. for 15 sec, whereby an undercoat layer was provided.

Furthermore, a recording layer forming coating solution 3 below was coated so that a coating amount was 1.4 g/m², followed by drying at 140° C. for 100 sec by using PERFECT OVENPH 200 manufactured by TABAI Corp., with Wind Control thereof set at 7, whereby planographic printing plate precursors according to examples 17 through 32 were obtained. Still furthermore, another planographic printing plate precursor was prepared as comparative example 4 in which the recording layer coating solution 3 did not contain a lipophilic polymer according to the invention. Yet another planographic printing plate precursor was prepared as comparative example 5 in which the recording layer coating solution 3 used, in place of the lipophilic polymer, a fluorinated surfactant. Yet another planographic printing plate precursor was prepared as comparative example 6 in which the recording layer coating solution 3 used, in place of the lipophilic polymer, a fluorinated polymer.

<Recording Layer Forming Solution 3>

| | | |
|---|---|---|
| Novolak resin (m/p-cresol (6/4), | 0.90 | g |
| weight average molecular weight: 7000, | | |
| unreacted cresol: 0.5% by weight) | | |
| Ethyl methacrylate/isobutyl | 0.10 | g |
| methacrylate/methacrylic acid | | |
| (35/35/30% by mole) copolymer | | |
| Cyanine dye A (formula shown above) | 0.10 | g |
| Phthalic acid anhydride | 0.05 | g |
| P-toluene sulfonic acid | 0.002 | g |
| Ethyl violet of which counter ion had | 0.02 | g |
| been replaced with | | |
| 6-hydroxy-β-naphthalene sulfonate | | |
| Fluorinated surfactant (Defensa F-780F | 0.015 | g |
| (solid content: 30%), | | |
| manufactured by Dai Nippon Ink and Chemicals, | | |
| Incorporated) | | |
| Lipophilic polymer (a compound described in | 0.035 | g |
| Table 2) | | |
| Methyl ethyl ketone | 12 | g |

[Observation of Shape of Halftone Dot]

Each of planographic printing plate precursors thus obtained of examples and comparative examples was exposed imagewise with TrenndSetter 800 Quantum (trade name, manufactured by CREO Corp.,) at 10 W/250 rpm. Subsequently, an automatic processor LP-940H, of which developing bath was charged with a PS processor developer [DT-2] (trade name, manufactured by Fuji Photo Film Co., Ltd.) under standard use conditions (1:8) and of which third bath was charged with FP-2W, was used for development. A 50% halftone dot shape of each of the planographic printing plates thus obtained was observed with a loupe and evaluated according to criteria below.
◯: a shape of halftone dot was clear
Δ: a halftone dot shape was slightly coarse
X: a halftone dot shape was coarse
   [Evaluation of Wasted Sheet at the Start of Printing]

Each of thus prepared planographic printing plates was applied to a printer (trade name: SOR-M, manufactured by Heidelberg Drucksmaschinen AG) to print with ink (trade name: High Unity MZ, manufactured by TOYO INK MFG Co., Ltd.) and dampening water IF-102 (4% dilution) (trade name, manufactured by FUJI PHOTO FILM Co., Ltd.). At the start of printing, the number of sheets needed before an excellent image concentration as a printed matter was obtained was evaluated as wasted sheets at the start of printing. Results are shown in Tables 1 and 2 below.

TABLE 1

| | | | | Contact angle (°) | | | Number of |
|---|---|---|---|---|---|---|---|
| | | | | Oil droplet | Water droplet | Halftone dot | spoilage at the start |
| Example | Support | Polymer | | in water | in oil | shape | of printing process |
| Example 1 | Support 1 | F-1/O-3/A-1 | 30/50/20 | 68 | 142 | ◯ | 7 |
| Example 2 | Support 2 | F-5/O-7/A-2 | 40/35/25 | 64 | 144 | ◯ | 6 |
| Example 3 | Support 3 | F-5/O-10/A-5 | 35/45/20 | 67 | 145 | ◯ | 7 |
| Example 4 | Support 1 | F-5/O-4/A-7 | 25/55/20 | 63 | 143 | ◯ | 6 |
| Example 5 | Support 1 | F-6/O-8/A-5 | 30/55/15 | 65 | 144 | ◯ | 6 |
| Example 6 | Support 1 | F-6/O-5/A-4 | 25/55/20 | 66 | 144 | ◯ | 6 |
| Example 7 | Support 1 | F-6/O-9/A-3 | 20/50/30 | 64 | 145 | ◯ | 5 |
| Example 8 | Support 1 | F-6/O-6A-6 | 30/50/20 | 62 | 147 | ◯ | 5 |
| Example 9 | Support 1 | F-7/O-4/A-8 | 35/45/20 | 67 | 144 | ◯ | 6 |
| Example 10 | Support 1 | F-7/O-8/A-5 | 30/55/15 | 69 | 142 | ◯ | 7 |
| Example 11 | Support 1 | F-8/O-9/A-4 | 30/45/25 | 64 | 148 | ◯ | 5 |
| Example 12 | Support 1 | F-8/O-10/A-7 | 25/50/25 | 65 | 145 | ◯ | 6 |
| Example 13 | Support 1 | S-3 | | 68 | 142 | ◯ | 8 |
| Example 14 | Support 2 | S-4 | | 67 | 143 | ◯ | 7 |
| Example 15 | Support 3 | S-5 | | 69 | 141 | ◯ | 8 |
| Example 16 | Support 1 | S-6 | | 68 | 142 | ◯ | 7 |

| | | | | | | |
|---|---|---|---|---|---|---|
| Comparative | Support 1 | None | 80 | 125 | X | 40 |
| example 1 | | | | | | |
| Comparative | Support 1 | Defensa F-781F, | 75 | 137 | X | 25 |
| example 2 | | manufactured by Dainippon | | | | |
| | | Ink and Chemicals | | | | |
| | | Co., Ltd. | | | | |
| Comparative | Support 1 | Fluorinated polymer | 72 | 135 | Δ | 30 |
| example 3 | | according to example 1 of | | | | |
| | | JP-A No. 2003-21907 | | | | |

TABLE 2

| | | | | Contact angle (°) | | | Number of |
|---|---|---|---|---|---|---|---|
| | | | | Oil droplet | Water droplet | Halftone | spoilage at the start |
| Example | Support | Polymer | | in water | in oil | dot shape | of printing process |
| Example 17 | Support 1 | F-1/O-3/A-1 | 30/50/20 | 69 | 141 | ◯ | 7 |
| Example 18 | Support 2 | F-5/O-7/A-2 | 40/35/25 | 66 | 142 | ◯ | 7 |
| Example 19 | Support 3 | F-5/O-10/A-5 | 35/45/20 | 68 | 143 | ◯ | 8 |
| Example 20 | Support 1 | F-5/O-4/A-7 | 25/55/20 | 65 | 142 | ◯ | 7 |
| Example 21 | Support 1 | F-6/O-8/A-5 | 30/55/15 | 67 | 144 | ◯ | 6 |
| Example 22 | Support 1 | F-6/O-5/A-4 | 25/55/20 | 68 | 142 | ◯ | 7 |
| Example 23 | Support 1 | F-6/O-9/A-3 | 20/50/30 | 66 | 143 | ◯ | 6 |
| Example 24 | Support 1 | F-6/O-6/A-6 | 30/50/20 | 65 | 144 | ◯ | 6 |
| Example 25 | Support 1 | F-7/O-4/A-8 | 35/45/20 | 68 | 142 | ◯ | 7 |
| Example 26 | Support 1 | F-7/O-8/A-5 | 30/55/15 | 69 | 141 | ◯ | 8 |
| Example 27 | Support 1 | F-8/O-9/A-4 | 30/45/25 | 66 | 145 | ◯ | 7 |
| Example 28 | Support 1 | F-8/O-10/A-7 | 25/50/25 | 67 | 143 | ◯ | 7 |
| Example 29 | Support 1 | S-3 | | 69 | 140 | ◯ | 8 |
| Example 30 | Support 2 | S-4 | | 68 | 141 | ◯ | 8 |
| Example 31 | Support 3 | S-5 | | 69 | 140 | ◯ | 8 |
| Example 32 | Support 1 | S-6 | | 68 | 141 | ◯ | 8 |

| | | | | | | |
|---|---|---|---|---|---|---|
| Comparative | Support 1 | None | 85 | 121 | X | 55 |
| example 4 | | | | | | |
| Comparative | Support 1 | Defensa F-781F, | 78 | 134 | X | 35 |
| example 5 | | manufactured by | | | | |
| | | Dainippon Ink and | | | | |
| | | Chemicals Co., Ltd. | | | | |
| Comparative | Support 1 | Fluorinated polymer | 75 | 133 | Δ | 35 |
| example 6 | | according to example 1 of | | | | |
| | | JP-A No. 2003-21907 | | | | |

From the results shown in Tables 1 and 2, it is confirmed that, by using the planographic printing plate precursors of the present invention, i.e., of examples 1 to 32, which possess the lipophilic surface physical properties defined by the invention, planographic printing plate excellent in the halftone spot reproducibility and less number of wasted sheets at the start of printing can be obtained. Furthermore, it is confirmed that such physical properties of the printing precursor can be obtained by adding a specific lipophilic polymer according to the invention thereto.

On the other hand, it is confirmed, even in a case of a recording layer containing a polymer having a fluorine-based functional group or a fluorine-based surfactant, in the case of a planographic printing plate precursor having a recording layer of which surface physical properties are outside the scope of the invention, the sharpness of a halftone dot shape is poor and the number of wasted sheets produced at starting printing with a planographic printing plate thus obtained is significantly large, as compared with present examples.

What is claimed is:

1. A planographic printing plate precursor, comprising:
a support; and
a recording layer disposed on the support and containing an alkali-soluble polymer compound and an infrared absorber;
wherein a contact angle at a surface of the planographic printing plate precursor is 70° or less in a case of oil in water and 140° or more in a case of water in oil.

2. The planographic printing plate precursor according to claim 1, wherein the recording layer includes a polymer having a lipophilic functional group on a side chain thereof.

3. The planographic printing plate precursor according to claim 2, wherein the polymer having a lipophilic functional group contains, as a copolymerization component, a monomer having a lipophilic functional group on a side chain thereof at a ratio in a range of 10 to 60% by mole.

4. The planographic printing plate precursor according to claim 2, wherein the lipophilic functional group is selected from a group constituted of an alkyl group, a cycloalkyl group, a bicyclo ring and a tricyclo ring.

5. The planographic printing plate precursor according to claim 2, wherein the polymer having a lipophilic functional group contains, as a copolymerization component, a monomer having a fluoroalkyl group.

6. The planographic printing plate precursor according to claim 5, wherein the fluoroalkyl group is contained at a ratio in a range of 5 to 50% by mole.

7. The planographic printing plate precursor according to claim 2, wherein the polymer having a lipophilic functional group contains, as a copolymerization component, a monomer having an acid group.

8. The planographic printing plate precursor according to claim 2, wherein the polymer having a lipophilic functional group is a silicon base polymer.

9. The planographic printing plate precursor according to claim 1, wherein the recording layer is a recording layer having a multi-layer structure or a recording layer having a dispersion phase.

10. The planographic printing plate precursor according to claim 9, wherein the recording layer includes a lower layer disposed on the support and a top layer disposed on the lower layer.

11. The planographic printing plate precursor according to claim 10, wherein the top layer contains a polymer having a lipophilic functional group on a side chain thereof.

12. The planographic printing plate precursor according to claim 10, wherein the lower layer is a layer excellent in the alkali-solubility.

13. The planographic printing plate precursor according to claim 9, wherein the recording layer contains at least two types of alkali-soluble polymer compounds, and at least one type of the alkali-soluble polymer compound forms a dispersion phase in the recording layer.

14. A planographic printing plate precursor, comprising:
a support; and
a recording layer disposed on the support;
wherein at least a surface layer portion of the recording layer contains an alkali-soluble polymer compound having a phenolic hydroxy group, an infrared absorber and a polymer having a lipophilic functional group on a side chain thereof; and
a contact angle at a surface of the recording layer is 70° or less in a case of oil in water and 140° or more in a case of water in oil.

15. The planographic printing plate precursor according to claim 14, wherein the polymer having a lipophilic functional group contains, as a copolymerization component, a monomer having a lipophilic functional group on a side chain thereof at a ratio in the range of 10 to 60% by mole.

16. The planographic printing plate precursor according to claim 14, wherein the lipophilic functional group is selected from a group consisting of an alkyl group, a cycloalkyl group, a bicyclo ring and a tricyclo ring.

17. The planographic printing plate precursor according to claim 14, wherein the polymer having a lipophilic functional group contains, as a copolymerization component, a monomer having a fluoroalkyl group.

18. The planographic printing plate precursor according to claim 14, wherein the recording layer consists of a lower layer disposed on the support and a top layer disposed on the lower layer, the top layer containing the alkali-soluble polymer compound having a phenolic hydroxy group, the infrared absorber and the polymer having a lipophilic functional group on a side chain thereof.

19. The planographic printing plate precursor according to claim 14, wherein the recording layer contains another alkali-soluble polymer compound different from the alkali-soluble polymer compound having a phenolic hydroxy group, and the alkali-soluble polymer compound having a phenolic hydroxy group is present as a dispersion phase in the another alkali-soluble polymer compound.
